(19) United States
(12) Patent Application Publication
(10) Pub. No.: US 2007/0051749 A1
(43) Pub. Date: Mar. 8, 2007

(54) Adjustable flow liquid dispenser

(76) Inventors: Philip B. Fleet, Reston, VA (US); Mark D. Norwood, Randallstown, MD (US); Donald P. Reilly, Baltimore, MD (US); Mark T. MacLean-Blevins, Westminster, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/385,808

(22) Filed: Mar. 22, 2006

Related U.S. Application Data
(60) Provisional application No. 60/714,352, filed on Sep. 7, 2005.

(51) Int. Cl. B67D 5/52; G01F 11/00

(52) U.S. Cl. 222/137; 222/389; 222/145.7

(57) ABSTRACT

An apparatus that is an adjustable and selective dispensing system for dispensing at least two flowable materials, and into which can be inserted a set of cartridges containing the flowable materials. Each cartridge has a piston end and a metering end. Each cartridge includes a moveable piston at its piston end driven by compressed air pressure created by actuating a pump assembly also resident in the dispensing system. The dispensing system also contains a set of metering discs, one of which adjoins each of the cartridges at the metering end thereof, for selectively dispensing the flowable materials from the cartridges. There are a set of conduits adjacent each of the metering discs for providing a predetermined amount of the flowable materials to be dispensed. A metering control mechanism rotationally actuating the metering discs for controlling the flow of the flowable materials from each of the cartridges is also provided.

### REFERENCE TO RELATED APPLICATIONS

This patent application is based upon Provisional Application Ser. No. 60/714,352 filed 7 Sep. 2005.

### BACKGROUND OF THE INVENTION

1. Field of the Invention

The present invention is directed to a reusable and variably adjustable dispensing system for multiple food products for retail (consumer home and travel) and commercial (restaurant and institutional) use.

2. Description of the Prior Art

Multiple food flavoring sauces and containers for dispensing the sauces currently exist. However, the vast majority of these embodiments are designed for delivery of one sauce at a time. With these existing containers, the user controls the intensity of the result solely by varying the volume dispensed and/or varies the flavor by combining multiple products from multiple dispensers, all in a relatively imprecise manner.

Existing food flavoring sauce dispensers typically require or suggest total replacement when empty. This increases the cost for retail and commercial consumers of dispensing systems and therefore is a negative aspect of conventional food flavoring sauce dispensing systems known in the art. Additionally, many conventional food dispensing systems expose users (especially in multiple user environments) to increased food safety risks due to handling issues, such as fingers touching the exit orifice during removal or replacement of the cap or during rotation of a spout valve.

Dispensing systems with some attributes similar to the subject invention exist for other (mainly non-food) products, such as toothpaste, tanning lotion, epoxies, cosmetics, etc., allowing for metering, mixing and/or dispensing multiple components, but these often include deficiencies such as: residue from previous selection taints the next selection; the housing is not durable/reusable and/or cartridges are not replaceable in some dispensing systems; the operation and results are too dependent on gravitational pull or the method of operation otherwise provides too limited a range of permitted configurations or orientations of the component parts; some dispensing systems do not allow for precise, continuous variability from 0%-100% of each component nor for an “off” condition whereby no product is dispensed; the product to be dispensed is not as well protected from potential contaminants and/or other safety and hygiene issues are not adequately addressed; and some dispensing systems are not designed to promote or enhance the enjoyment (fun factor) of use.

In light of the foregoing shortcomings of conventional dispensing systems known in the art, there is an apparent, unfulfilled need in the art for a method of operation and corresponding dispensing system which is continuously variable to allow flavor according to a user's taste, while also being reliably precise, reusable, safe and fun.

### SUMMARY OF THE INVENTION

The present invention overcomes the previously described shortcomings of conventional dispensing systems known in the art by providing a durable, reusable, and food-safe dispensing system in which replaceable cartridges with at least two different flowable liquids are incorporated and also giving the user the ability to select the composition of the product dispensed by varying the proportion of liquid from each cartridge from 0%-100% (as long as the sum of the ratios from all cartridges totals 100%), as well as providing an “off” condition at which no product is dispensed from any cartridge.

In a preferred embodiment of the present invention, as illustrated in the accompanying drawings, there is a dispensing system that includes two housing sections, which are removably displaceable from each other, for access to the cartridges within. In one of these housing sections is located a set of cartridges, each cartridge including a piston end and a metering end. Each cartridge contains a liquid material and a moveable piston for pushing that material out of the cartridge. Each piston is driven by compressed air delivered by a user-actuated pump element, which is also part of the dispensing system. The dispensing system further contains a set of metering discs which adjoin the metering end of the cartridges, for selectively controlling the throughput of flowable materials from the cartridges. These metering discs are attached to the cartridges and are further supported by a set of seal plates which are connected to an assemblage of dispensing conduits, and these conduits lead to a coaxial dispensing conduit and coaxial dispensing opening through which the predetermined selection of liquid material ultimately exits the dispensing system. A metering control mechanism in the form of a user-manipulated selection knob (or dial), also resident with the dispensing system, rotationally drives a set of gears which translate the user's selection into the proper rotation of the metering discs, to control the flow of liquid material from each of the cartridges, through the coaxial dispensing conduit and out of the coaxial dispensing opening.

It is an object of the present invention to allow the user to select his or her desired flavor and intensity (for example, type of cuisine involved and heat/pungency of hot sauce) using one dispensing system, while at the same time better controlling the specificity of the selection and the repeatability of the result.

It is another object of the present invention to provide a method of using a dispensing system for the adjustable and selective dispensing of at least two liquid materials.

It is another object of the present invention to eliminate the need for multiple bottles, and therefore reduce storage and point of use space required to deliver a wide range of flavor options, which also improves efficiency and reduces cost.

It is yet another object of the present invention to incorporate easily removable and replaceable cartridges with a user-controlled blend-selection dial, allowing for widely variable flavor and heat combinations for different cuisines (e.g. BBQ, Mexican Asian, Indian, etc.), the differing taste buds of communal users (e.g. different appreciation or tolerance for spicy foods) and/or the varied moods of one user.

It is yet another object of the present invention to reduce food safety risks due to handling issues by placing a finger-activated dial and pump away from the delivery spout and by including a cap or other cover mechanism to minimize manual contact with the spout.

It is still another object of the present invention to provide a sauce (or other liquid) dispensing bottle (which is considered to be durable), with at least two replaceable inner cartridges (which are considered to be disposable), filled with product(s) of varying flavor and viscosity, with a control means (such as a circular dial), by which the user can select the desired blend (i.e., heat intensity for hot sauce uses) by adjusting the numerical selection on the dial and pushing a button or pump to initiate the extraction and delivery of the sauce. Upon actuation of the pump, compressed air is forced over the cartridge-resident pistons such that the proper portions of liquid are issued through each cartridge's metering discs and delivered via an internal set of conduits and co-axial exit orifice (which the user directs as desired onto food). The dispensing system is conceived to allow the user to visibly determine, at all times and without separate action, which type of cartridges are resident and the remaining volume of the product in each of the replaceable cartridges. In addition, the dispensing system is arranged to prevent dispensing when the user's selection requires product from a cartridge which is empty or missing. The dispensing control means will provide an “off” condition whereby no product will be dispensed from any cartridge. This “off” condition will also allow for safe cartridge removal and replacement without risk of spillage. The metering control means as conceived allows complete and full variation from zero to full flow for each replaceable cartridge, based on the user-selected increments on the dial. The pump element allows the user to control the delivered volume of end product, and provides a slight pull-back vacuum to help prevent dripping or product-buildup within the coaxial dispensing opening (which could taint the next user's selection.) The dispensing system is designed to be a closed and sterile system; as such, the delivery orifice is conceived to be closed or behind moveable closure. As much as possible, the delivery system (its manifold and delivery orifice) is to be designed to allow storage and use in any orientation.

### BRIEF DESCRIPTION OF THE DRAWINGS

FIG. 1 is a perspective view of the dispensing system of the subject invention;

FIG. 2 is a partially rotated perspective view of the dispensing system of the subject invention;

FIG. 3 is a frontal view of the dispensing system of the subject invention;

FIG. 4 is a side view of the dispensing system of the subject invention;

FIG. 5 is a further side view of the dispensing system of the subject invention;

FIG. 6 is a vertical cross-section view of the dispensing system taken along the cross-sectional lines 6-6 of FIG. 5;

FIG. 7 is a vertical cross-section of a side view of the dispensing system taken along the section lines 7-7 of FIG. 3;

FIG. 8 is a vertical cross-section taken along the section lines 8-8 of FIG. 4, showing the pump assembly, cartridges, and conduits of the dispensing system;

FIG. 9 is a vertical cross-section with a block arrow showing actuation of the pump assembly and directional arrows showing the flow of air to the pistons of the cartridges of the dispensing system of the subject invention taken along the section lines 9-9 of FIG. 5;

FIG. 10 is a vertical cross-section showing the dispensing opening of the dispensing system of the subject invention;

FIG. 11 is a vertical cross-section showing the selection drive assembly of the dispensing system of the subject invention;

FIG. 12 is a horizontal cross-section showing the output side of the metering discs of the dispensing system with the seal plates and dispensing conduits removed;

FIG. 13 is a perspective view of the dispensing system with the bottom of the housing cut away;

FIG. 14 is a perspective view of a cartridge for use within a dispensing system of the subject invention;

FIG. 15 is a perspective view of another disposable and replaceable cartridge of the subject invention;

FIG. 16 is a cut away view of the dispensing system with a disposable and replaceable cartridge positioned on a housing of the dispensing system;

FIG. 17 is a vertical cross-section of the metering end of a disposable and replaceable cartridge of the subject invention.

### DETAILED DESCRIPTION OF THE PREFERRED EMBODIMENTS

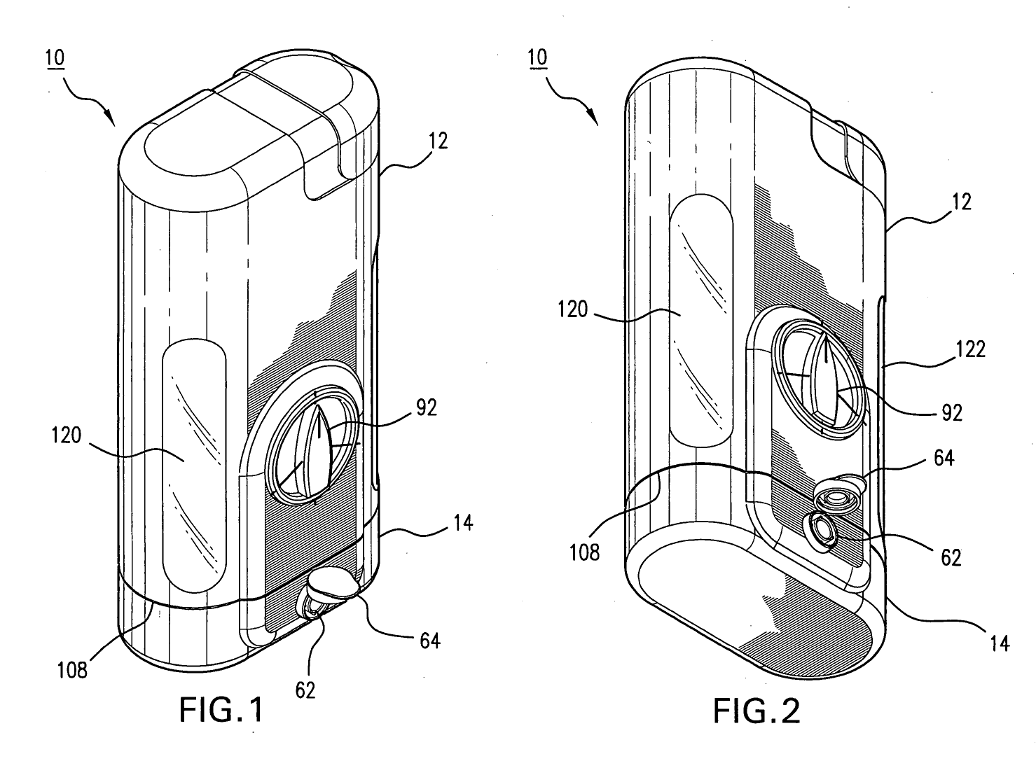

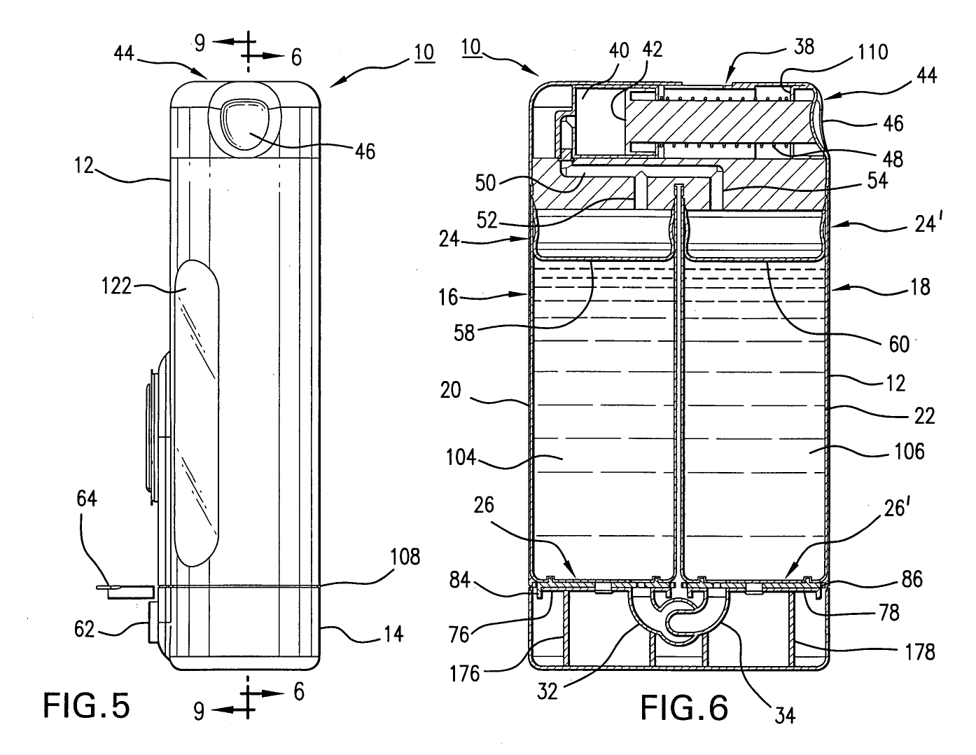

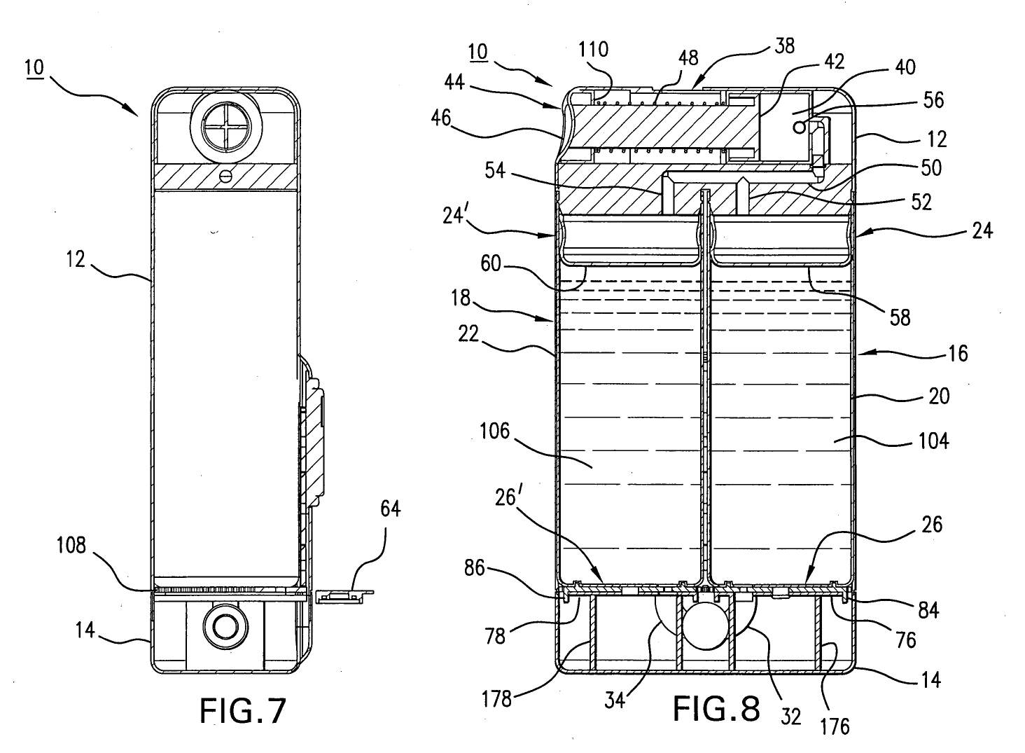

Referring now to FIGS. 1-17, there is shown adjustable and selective dispensing system 10 for dispensing at least two flowable liquid materials 104, 106 through a coaxial dispensing opening 62 clearly shown in FIGS. 1 and 2. As will be further described, the user selects his or her desired ratio of liquid materials 104, 106 by rotating selection knob 92 and then initiates delivery of this desired composition by using the pump assembly 38 to create air pressure necessary to force movable pistons within cartridges 20 and 22 to impart pressure upon liquid materials 104 and 106, also resident within cartridges 20 and 22, thereby forcing the liquid materials 104, 106 through a flow metering mechanism, also to be further described, before the desired ratio of liquid material 104, 106 ultimately exits the dispensing system 10 through the coaxial dispensing opening 62.

Cartridges 20 and 22, which are disposable and replaceable, and which contain respective viscous liquid materials 104 and 106, are insertable within dispensing system 10 for controlled and selective dispensing of fluids through coaxial dispensing opening 62, as will be detailed in following paragraphs. Cartridges 20 and 22 may be formed of plastic or some like material which is not porous and properly contains the liquid materials 104 and 106.

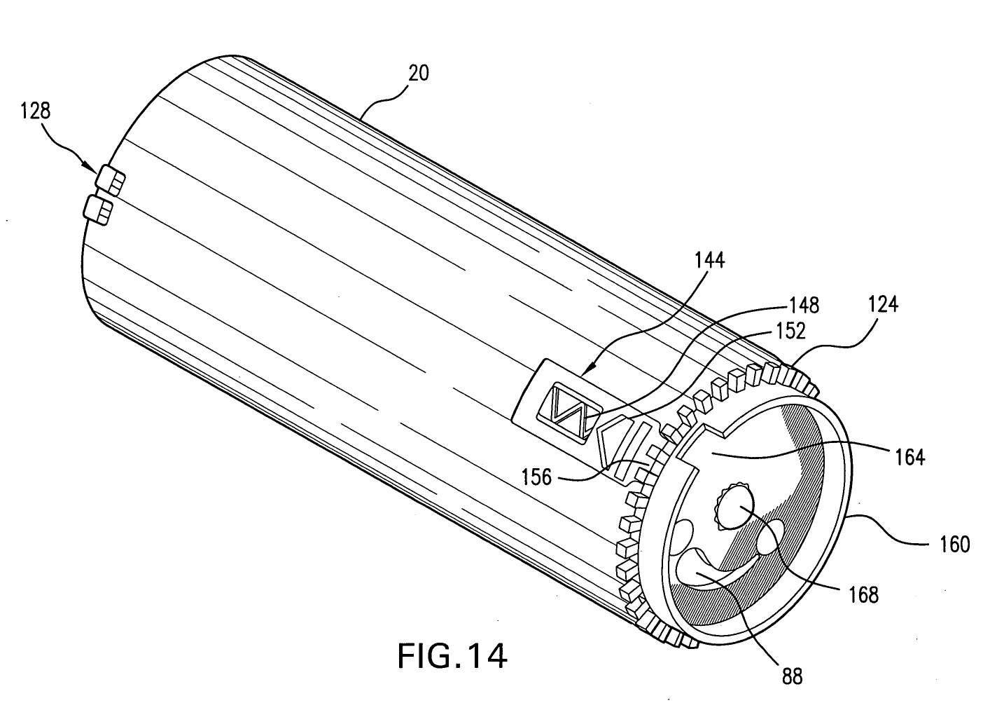

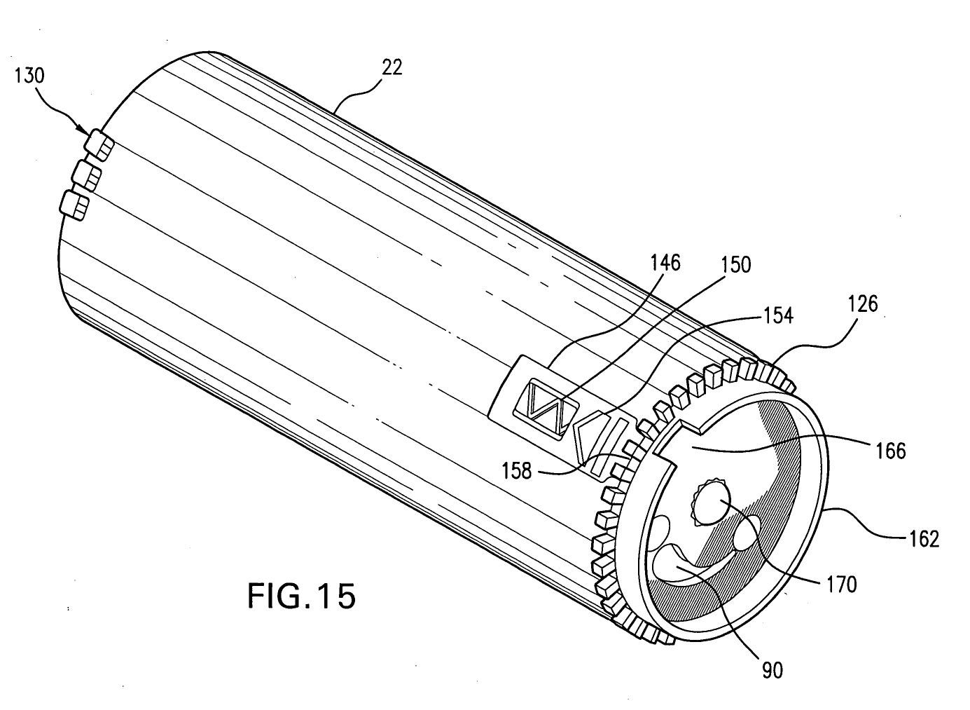

In general, cartridges 20 and 22, as shown in FIG. 14-17, will be transparent or opaque and provided as an off-the-shelf item which may contain different sauces/liquids of varying ingredients, viscosity and/or taste intensity. As will be described, dispensing system 10 can be selectively attuned to provide a combination of liquid materials 104 and 106 in particular ratios as selected by the user according to the user's taste criteria. In fact, dispensing system 10 and cartridges 20 and 22 may be used for a wide variety of selective dispensing of liquid materials 104 and 106 to provide a predetermined flow ratio and combination of liquid materials 104 and 106 for purposes desired by a user. Cartridges 20 and 22 are clearly shown in FIGS. 6 and 8 subsequent to insertion within dispensing system 10 and in FIGS. 14, 15 prior to insertion within dispensing system 10.

In fact, cartridges 20 and 22 are slidably insertable within dispensing system 10 and removable therefrom, as will be detailed in following paragraphs. The user has the ability to dispense liquid materials 104 and 106 in a predetermined flow ratio until one or both of cartridges 20 and 22 are emptied, whereby user would insert a new cartridge 20, 22 within dispensing system 10.

The present dispensing system 10 allows a user to remove and replace the cartridges 20, 22 before either is empty, should he or she wish to do so (for example, to switch from a set of cartridges 20, 22 containing liquid materials 104, 106 intended for one type of cuisine to a different set of cartridges 20, 22 with a different variety of liquid materials 104, 106 intended for another type of cuisine.) Dispensing system 10 includes cartridge viewing windows 120 and 122, as shown in FIGS. 1-5, each of which readily provides a view of at least some portion of respective cartridges 20 and 22, when the cartridges are resident in dispensing system 10, such that the user can quickly and easily determine which variety of cartridges 20, 22 is installed, as well as the remaining fill volume level of each such cartridge 20, 22.

Referring now to FIGS. 1-11, adjustable and selective dispensing system 10 or dispensing system 10 includes first housing section 12 and second housing section 14. Second housing section 14 is removably displaceable into one piece formation with first housing section 12 and is removable therefrom for removal and insertion of cartridges 20 and 22. First and second housing sections 12 and 14 may be formed of a plastic type composition or some like material which is of a closed cell composition and non-porous. Second housing section 14 is mounted in mating engagement with first housing section 12 through any of a number of fastening techniques such as a force fit, snapping, or some like technique not important to the inventive concept that is herein described, with the exception that first housing section 12 and second housing section 14 be matingly engageable in a tightened one piece formation technique to maintain a unitary structure of dispensing system 10 during operation, transport, storage or display, and also that these housing sections 12, 14 be lockable one to the other, under certain conditions, as will be described in following paragraphs.

Engagement line 108 defines the interface between second housing section 14 and first housing section 12. In this manner, second housing section 14 and first housing section 12 may be removed each from the other for insertion and removal of cartridges 20 and 22 and/or for cleaning or other maintenance as desired, while maintaining a unitary structure at other times (during shipping, storage, display, operation, etc.)

Referring back to FIGS. 1-3, there is shown selection knob 92, which could be a circular dial as shown or some similarly selective device, positioned on the front exterior of first housing section 12. The user rotatably turns selection knob 92 to choose his or her desired combination of liquid materials 104 and 106, ranging from a selection constituted 100% of liquid material 104 and 0% of liquid material 106 to a selection the composition of which is 0% liquid material 104 and 100% liquid material 106, including any intermediate variation within that range, the sum of which ratios total 100%, for example 35% liquid material 104 and 65% liquid material 106, and with the specificity of such intermediate selections limited only by the number of incremental stops, if any, designed into this dispensing system 10.

As will be further described, the selection knob 92 also allows the user to select an “off” condition, whereby no liquid material will be released from any cartridge, first and second housing sections 12 and 14 will be unlocked one from the other to permit disassembly, and at which setting either or both of the cartridges 20 and 22 can be safely removed and replaced.

Referring back to FIGS. 6, 8-10 and 14-17, cartridges 20 and 22 are positioned in first housing section 12. Each of cartridges 20 and 22 is housed within its respective cartridge chamber 16, 18, both of which are part of first housing section 12. Each cartridge chamber 16, 18 is a defined area within the first housing section 12 that receives a specific cartridge 20 or 22 based on cartridge alignment and securing features, detailed in following paragraphs.

Each cartridge 20, 22 and its respective cartridge chamber 16, 18 include cartridge alignment and securing features to ensure that the user properly inserts cartridge 20 into cartridge chamber 16 and cartridge 22 into cartridge chamber 18, as will be further described.

Referring again to FIGS. 6, 8-10 and 14-17, each of cartridge 20 and 22 has respective piston ends 24, 24′ and metering ends 26, 26′, as is shown. As will be seen in following paragraphs, liquid materials 104 and 106 are driven by cartridge pistons 58 and 60, under compressed air pressure, out of cartridges 20 and 22, for ultimate dispensing through coaxial dispensing opening 62.

As shown in FIG. 10, cartridges 20 and 22 include cartridge outlet openings 116 and 118, through which liquid materials 104 and 106 exit the cartridges and immediately flow through the adjoining metering discs 84 and 86, as further described in following paragraphs.

Referring now to FIGS. 14-17, each of the cartridges 20, 22 has a respective cartridge alignment key set 128, 130. The cartridge alignment key set 128, 130 of each cartridge 20, 22 facilitates respectively the insertion of the cartridges 20, 22 into the respective cartridge chambers 16, 18. The cartridge alignment key set 128 (of cartridge 20), 130 (of cartridge 22), is located near each respective piston end 24, 24′. However, the cartridge alignment key set 128, 130 of each respective cartridge 20, 22 can be positioned at any point on a respective cartridge 20, 22 as long as a corresponding set is positioned accordingly within the cartridge chamber 16, 18.

The cartridge alignment key set 128, 130 of each respective cartridge 20, 22 functions to ensure correct alignment of each cartridge 20, 22 with its intended cartridge chamber 16, 18. Therefore, the cartridge alignment key set 128 ensures that the cartridge 20 will be inserted into cartridge chamber 16 and cartridge alignment key set 130 ensures that cartridge 22 will be inserted into cartridge chamber 18.

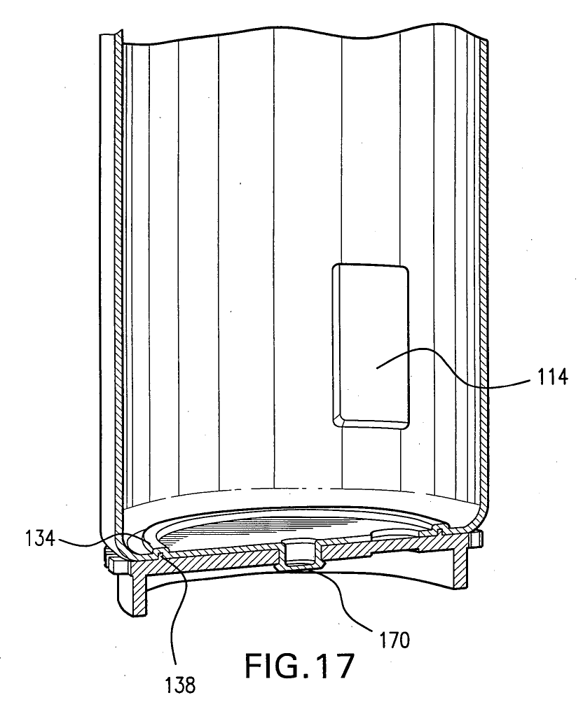

Referring again to FIG. 17, the cartridges 20, 22 further include cartridge piston air bypasses 112, 114 formed on each respective cartridge 20, 22. Each respective cartridge piston air bypass 112, 114 is in the form of a groove on each inner wall of a respective cartridges 20, 22. Each respective cartridge piston air bypass 112, 114 allow air to escape past the cartridge piston via the groove when the volume of contents in the cartridge 20, 22 nears or reaches empty. Each respective cartridge piston air bypass 112, 114 located on an inner wall of the cartridges 20, 22 is also positioned near the metering ends 26, 26′ of each cartridge 20, 22.

Each respective cartridge piston air bypass 112, 114 allows the release of pressure from the dispensing system (when the respective cartridge piston 58, 60 is displaced past the respective cartridge piston air bypass 112, 114) preventing further operation of the dispensing system 10 (since the respective cartridge piston 58, 60 will not be displaceable) when one or both of the cartridges 20, 22 are empty. Therefore, except for a selection of liquid material 104, 106 in which 100% of the undepleted liquid material 104 or 106 and 0% of the other depleted liquid material 104 or 106 is requested, the dispensing system 10 will not allow dispensing of a material when one cartridge 20, 22 is empty. Once a respective cartridge piston 58, 60 nears the end of a cartridge 20, 22, air will escape past the cartridge piston 58, 60 via the air piston bypass 112, 114 (by flowing through the groove) and prevent use of that cartridge 20 or 22 until it is replaced.

At the metering end 26, 26′, as described above, there are cartridge outlet openings 116, 118 in each respective cartridge 20, 22. The cartridge outlet openings 116, 118 are fixed openings that make up part of flow metering mechanisms 28, 30. The cartridge outlet openings 116, 118 allow liquid materials 104, 106 to flow out of the cartridges 20, 22 and through the metering disc openings 88, 90 formed on metering discs 84, 86 to be detailed in following paragraphs (if the metering discs 84, 86 have been rotated to a position whereby a passable opening aligns with cartridge outlet opening 116, 118).

Referring now to FIGS. 1-5, and 11, the dispensing system 10 includes cartridge viewing windows 120 and 122. The cartridge viewing windows 120, 122 are transparent windows formed in the housing which provides views into a respective cartridge chamber 16, 18. The cartridge viewing windows 120, 122 allow a user to easily and quickly determine whether a cartridge 20, 22 is installed, which variety of product is installed and the remaining liquid material 104, 106 in each installed cartridge 20, 22 (since the cartridge walls are also opaque or transparent).

Referring back to FIGS. 14-17, each cartridge 20, 22 further includes a plurality of metering disc gear teeth 124, 126. The metering disc gear teeth 124, 126 are formed on a respective metering disc 84, 86 of a respective cartridge 20, 22. The metering disc gear teeth 124, 126 engage a fourth gear 102 and are rotatively responsive to a rotation of the fourth gear 102. The metering disc gear teeth 124, 126 also function to lock a respective metering disc 84, 86 (in cooperation with each cartridges 20, 22 metering disc lock teeth 156, 158, to be detailed below) to prevent accidental or unintentional manual rotation of the metering disc 84, 86, when a cartridge 20, 22 is outside the dispensing system 10.

Referring again to FIGS. 14-17, each cartridge 20, 22 has a respective metering disc locking mechanism 144, 146. The metering disc locking mechanism 144, 146 keeps a respective metering disc 84, 86 fixed in an “off” condition when a cartridge 20, 22 is outside of the dispensing system 10. The metering disc locking mechanism 144, 146 ensures that a respective metering disc 84, 86 cannot be rotated and that no liquid material 104, 106 can escape from a respective cartridge outlet opening 116, 118 and that no material or contaminant can get into the cartridge 20, 22 and taint the liquid material 104, 106.

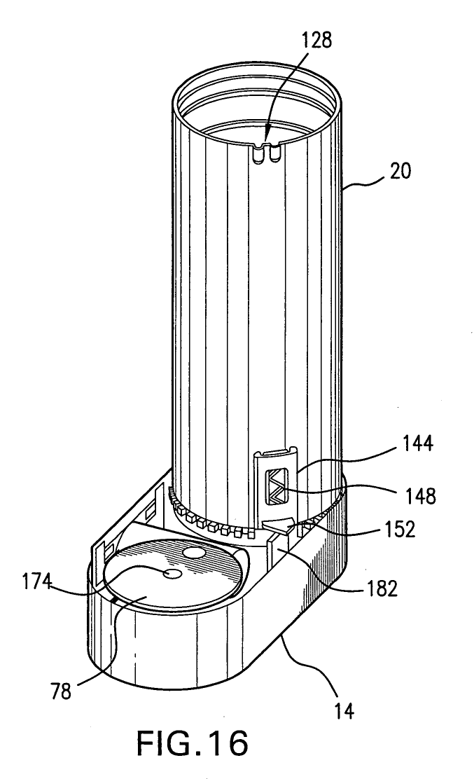

Each metering disc locking mechanism 144, 146 further includes a respective metering disc lock spring 148, 150, a respective metering disc lock cam 152, 154 and metering disc lock teeth 156, 158. Disposed inside of second housing section 14, there is a cam lift member 182, as shown in FIG. 16, protruding in the dispensing conduit behind the seal plates 76, 78, that pushes up against each respective metering disc lock cam 152, 154 of either cartridge's 20, 22 metering disc locking mechanism 144, 146. The cam lift member 182 abuts the metering disc lock cam 152, 154 when a cartridge 20, 22 is inserted in the dispenser, thus pushing the metering disc lock teeth 156, 158 of each respective metering disc locking mechanism 144, 146 out of engagement with the metering disc gear teeth 124, 126 which then frees the metering disc 84, 86 to be rotated in response to selection knob 92 rotation.

When a respective cartridge 20, 22 is not inserted in the dispensing system 10, the cam lift member 182 does not push or abut the metering disc locking mechanism 144, 146 of each respective cartridge 20, 22. Therefore, the metering disc locking mechanism 144, 146 engages the metering disc gear teeth 124, 126 and the metering disc lock springs 148, 150 forces the metering disc lock teeth 156, 158 into engagement with the plurality of metering disc gear teeth 124, 126. This prevents rotation of the metering discs 84, 86.

Referring again to FIGS. 14-15, each respective cartridge 20, 22 include a metering disc rim piece 160, 162. Each metering disc rim piece 160, 162 include a metering disc rim notch 164, 166. Each metering disc rim piece 160, 162 forms a portion of the metering disc 84, 86 that is affixed to each cartridge and fits around each cartridge's 20, 22 respective seal plate 76, 78. The metering disc rim piece 160, 162 ensures proper and secure orientation of each cartridge 20, 22 within the dispensing system 10.

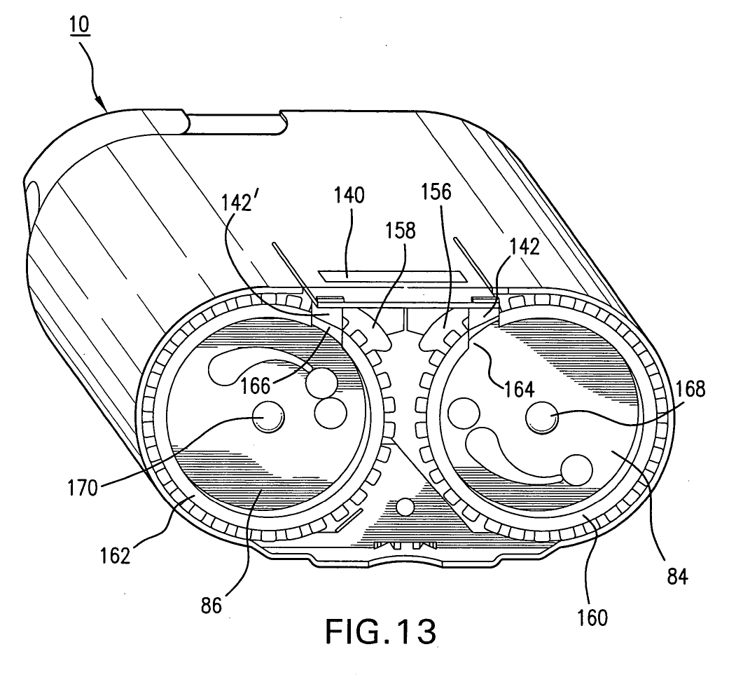

Referring to FIG. 13, first housing section 12 includes a pair of housing assembly latch prongs 142, 142′ on the dispenser interior side of the housing assembly latch release 140, with each of the housing assembly latch prongs 142, 142′ interacting with each cartridges 20, 22 metering disc rim piece 160, 162. An example of the interaction between the housing assembly latch prongs 142, 142′ and the metering disc rim piece 160, 162, is as follows: If the dispenser system 10 is not set to the “off” condition, the rim notches 164, 166 have not yet been rotated to the proper alignment to allow disassembly of the dispensing system 10, therefore, the pair of housing assembly latch prongs 142, 142′ will press against each respective metering disc rim piece 160, 162 of each cartridge 20, 22 when the cartridge 20, 22 are resident and the knob member is not set to “off”. This prevents the housing assembly latch release 140 from being actuated by a user as would be required to disengage the lock and disassemble each housing section (first housing section 12 and second housing section 14) each from the other of the dispensing system 10.

If the dispensing system is set to an “off” condition, each metering disc rim notch 164, 166 (a carved out notch in the rim piece 160, 162) rotates to the only position in which it can engage with its respective one of the housing assembly latch prongs 142, 142′, resident on the first housing section 12. Therefore, the housing assembly latch release 140 can be actuated to disengage the lock and allow for the dispensing system 10 disassembly (separation of first housing section 12 and second housing section 14). This method of association of each metering disc rim piece 160, 162 and interaction with the pair of housing assembly latch prongs 142, 142′ forces a user to place the dispensing system 10 in the “off” condition prior to opening or disassembling the dispensing system 10.

Referring back to FIGS. 14-15, each metering disc 84, 86 of each cartridge 20, 22 includes a metering disc fastener 168, (affixing metering disc 84 to cartridge 20) and 170 (affixing metering disc 86 to cartridge 22). The metering disc fasteners 168, 170 of each respective cartridge 20, 22 hold the metering discs 84, 86 securely to the metering end of the cartridges 20, 22 while allowing for their respective rotation. In this manner, the metering disc fasteners 168, 170 ensure that the metering discs 84, 86 remain fixed to the cartridges 20, 22 while allowing for their responsive rotation to the rotation of the selection knob 92 and the rotation of the gears while ensuring that the metering discs 84, 86 remain fixated.

There is a fastener head recess 172, 174 each respectively formed in the center of each seal plate 76, 78 which are shallow indentations for which the head of each metering disc fastener 168, 170 can fit when a cartridge 20, 22 is inserted into the dispensing system 10. This ensures that each seal plate 76, 78 presses firmly and evenly against its respective cartridge 20, 22 metering disc 84, 86. It is to be emphasized that the fastener head recess 172, 174 in each seal plate 76, 78 allows the metering discs 84, 86 to be flush with the seal plate 76, 78.

Referring to FIG. 17, each cartridge 20, 22, includes a seal groove 132, 134 which mates with a seal ridge 136, 138 respectively formed on each metering disc 84, 86. Each seal ridge 136, 138 is an annular protrusion on each respective metering disc 84, 86 and as described, mates with a respective seal groove 132, 134. The seal grove 132, 134, is molded onto each respective cartridge 20, 22. Each seal ridge 136, 138 on each respective metering disc 84, 86 along with each seal groove 132, 134 on each respective cartridge 20, 22 help to further seal the metering disc 84, 86 with its respective cartridge 20, 22 to prevent any leakage of liquid material 104, 106 due to environmental factors such as temperature change or atmospheric pressure changes, etc.

Referring to FIGS. 6, 8, 9-10, the second housing section 14 contains a pair of seal plate support members 176, 178 each respectively supporting a seal plate 76, 78. The seal plate support members 176, 178 help to ensure the seal plate is firmly positioned against each cartridge metering disc 84, 86, which further secures each cartridge 20, 22 in its proper cartridge chamber 16, 18. The seal plate support members 176, 178 also ensure proper orientation of each cartridge 20, 22 and minimize liquid material 104, 106 from leaking and also prevent entry of contaminant between the bottom cartridge wall, metering disc and the seal plate.

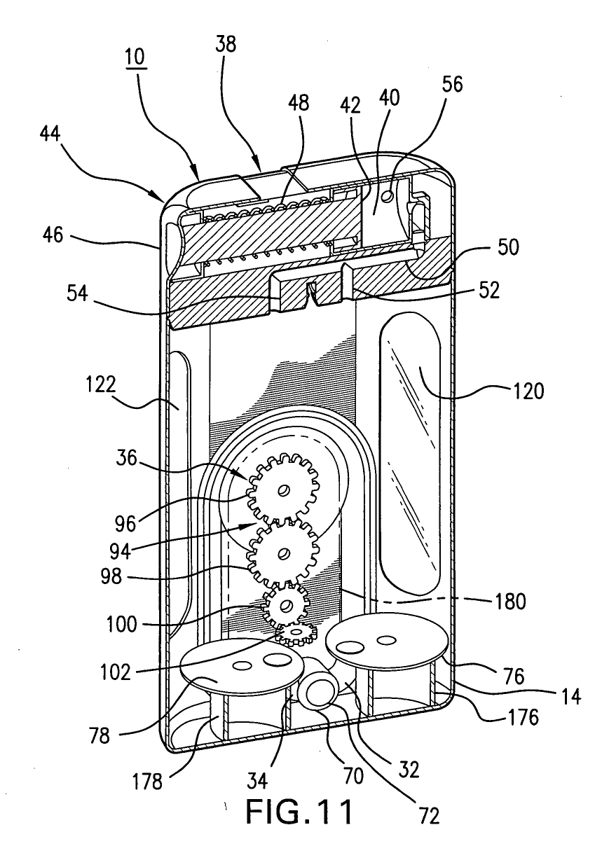

As can be seen in FIG. 11 (shown in phantom), there is a drive gear cover plate 180 which covers, and protects the drive assembly of gears. The drive gear cover plate 180 ensures no external contaminants affect the functional activity of the gear system to be described in the following paragraphs.

Referring now to FIGS. 6, 8, 9 and 10 dispensing system 10 is shown to further include pump assembly 38 located within first housing section 12. In overall concept, pump assembly 38 is manually operable to cause relatively high pressure air to act upon displaceable cartridge pistons 58 and 60 (to be further described in following paragraphs) and force liquid materials 104 and 106 through flow metering mechanism 28 and 30 and eventually out of coaxial dispensing opening 62.

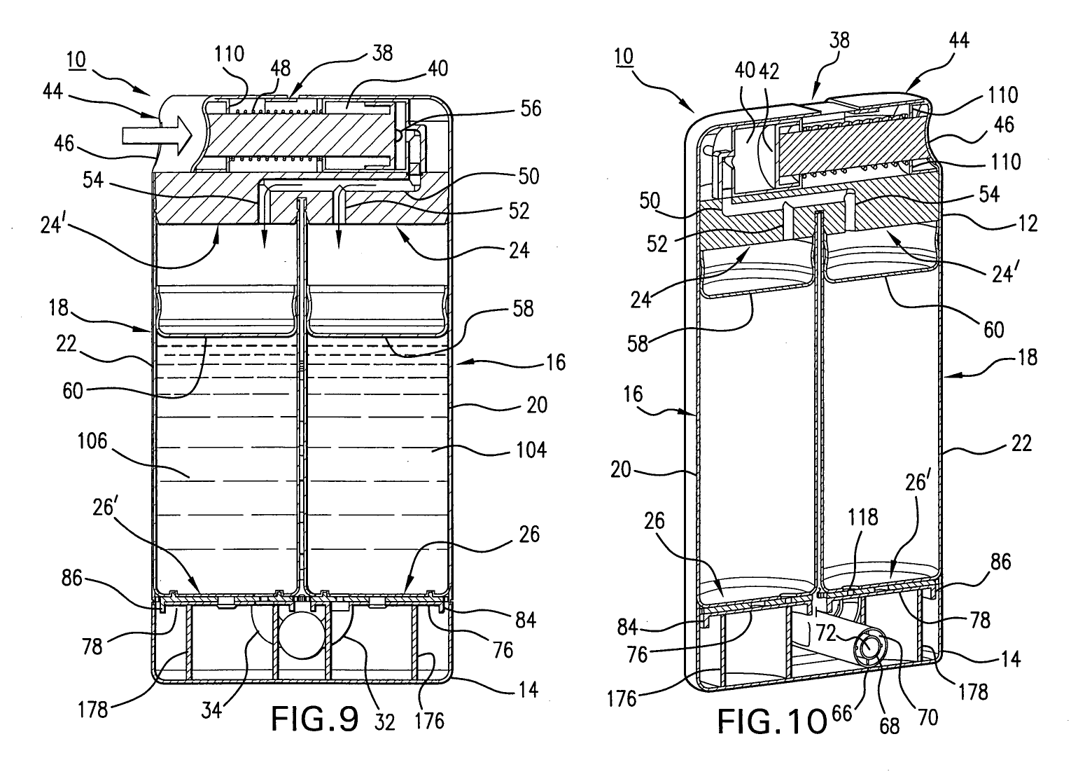

Pump assembly 38 includes biased displacing member 46 to be displaceable. Displacing member 46 may be a rod like member or some movable element which the user manually displaces as is clearly seen in FIGS. 9 and 10. Actuating mechanism 44 includes displacing member 46 in cooperation with spring member 48 and pump piston 42. As can be seen, pump piston 42 is secured and coupled to displacing member 46 on one end thereof. Pump piston 42 and displacing member 46 may be formed in one piece formation or secured through a one piece molding technique or other like techniques not important to the inventive concept of the subject invention with the exception that pump piston 42 be fixedly secured to displacing member 46 on one end thereof.

Spring member 48, which may be a coil spring, is mounted around displacing member 46 and interfaces with actuating wall 110 shown in FIGS. 6, 8, 9 and 10. In this manner, displacing member 46 is biased by spring member 48 and permits slidable displacement of displacing member 46 within pump chamber 40. Spring member 48 may be compressed by manual displacement of displacing member 46 to reduce the volume of pump chamber 40 and thereby increase the pressure of the air contained therein. Upon release of displacing member 46, pump chamber 40 is expanded in volume to reduce air pressure therein.

Displacement of displacing member 46 slidingly displaces pump piston 42 within pump chamber 40, producing a fluid flow of air into main air conduit 50, which is in fluid communication with pump chamber 40 and branch air conduits 52 and 54. Branch air conduit 52 is in fluid communication with main air conduit 50 and in alignment with cartridge 20, and air flowing through branch air conduit 52 results in a relatively high pressure air force acting on cartridge piston 58. Similarly, branch air conduit 54 is in fluid communication with main air conduit 50 and in itself is aligned with cartridge 22 to produce a relatively high pressure air force on cartridge piston 60.

In this manner, there is a continuous fluid communication between pump chamber 40, main air conduit 50 and branch air conduit 52 and branch air conduit 54. As high pressure air is charged through branch air conduits 52 and 54 respectively, cartridge pistons 58 and 60 are displaced to provide a force on liquid materials 104 and 106 contained within cartridges 20 and 22.

Referring now to FIG. 8, pump assembly 38 includes a vent and check valve 56 formed through a wall of the pump chamber 40, to allow atmospheric air to enter the pump chamber 40 when the pump piston 42 returns to an at-rest position (after actuation of the displacing member 46). Displacement of the displacing member 46 results in displacement of the pump piston 42. During displacement of the pump piston 42, the vent and check valve 56 prevent air from within the pump chamber 40 from escaping. After full displacement of the pump piston 42, the spring member 48 forces the pump piston 42 back to the at-rest position. As the pump piston 42 travels back to the at-rest position, a vacuum (negative pressure) is created until the pump piston 42 passes the vent and check valve 56, at which time the differential pressure (outside of pump chamber 40 versus inside of pump chamber 40) causes the vent and check valve 56 to open thereby allowing air external to the dispensing system 10 to enter into the pump chamber 40. Air will continue to enter through the vent and check valve 56 until the pump piston 42 returns to the at-rest position, at which time the check valve 56 will close.

As described, the spring member 48 forces the pump piston 42 back to the at-rest position after displacement by the displacing member 46. During return to the at-rest position by the pump piston 42, the pump piston 42 travels a pre-determined distance from the end of the pump chamber 40 to a vent opening of the vent and check valve 56. This pre-determined distance of travel by the pump piston 42 determines the magnitude of the vacuum (negative pressure) generated by the expanding volume created during the return to the at-rest position. The vacuum (negative pressure) causes a slight reversed displacement of the cartridge pistons 58, 60 and results in reversed displacement (or pull-back) of the liquid materials 104, 106 from within the coaxial dispensing opening 62. This reversed displacement (of both the cartridge pistons 58, 60 and ultimately liquid materials 104, 106) serves to aid in the prevention of drips, leaks and cross-contamination of the liquid contents within the coaxial dispensing opening 62.

Thus, as has been previously described, pump assembly includes pump piston 42 which is operable in a sliding manner within pump chamber 40. Pump piston 42 is biased by spring member 48. Pump assembly 38 further includes actuating mechanism 44 which includes displacing member 46, and spring member 48 for biasing displacing member 46 in a non-pumping condition. Main air conduit 50 is extended into pump chamber 40 and provides an air flow path from pump chamber 40 for actuation of cartridge pistons 58 and 60. Main air conduit 50 is bifurcated into branch air conduits 52 and 54, which are in fluid communication with pump chamber 40 through main air conduit 50. Branch air conduits 52 and 54 are in alignment with cartridge pistons 58 and 60 to provide a source of high pressure air for displacement of cartridge pistons 58 and 60 to permit displacement of fluid materials 104 and 106 contained therein.

Referring now to FIGS. 14-15, there are shown metering discs 84 and 86 respectively associated with metering the selected proportion of liquid products 104 and 106 from respective cartridges 20 and 22. Metering discs 84 and 86 are fixedly positioned adjoining cartridges 20 and 22 at metering end 26 and 26′ thereof to selectively dispense liquid products 104 and 106 from cartridges 20 and 22.

As detailed above, the pump assembly ensures proper flow of liquid materials 104, 106 through the cartridges 20, 22 and through the cartridge outlet openings 116, 118 and ultimately through the coaxial dispensing opening 62. However, once the pump mechanism is actuated and the pump piston 42 is displaced, return of the pump piston 42, as detailed above, to the at-rest state within the pump chamber 40 will cause a vacuum effect thereby pulling any remaining liquid material 104, 106 in the coaxial dispensing opening 62 back into the dispensing system 10 thereby creating a negative meniscus of liquid material 104, 106 at the dispensing opening 62. This prevents leakage or dripping of the liquid materials 104, 106 and also reduces tainting of a next use of the dispensing system 10.

Referring to FIGS. 14-15, the metering discs 84, 86 are fixedly and rotatably attached to the cartridges 20, 22, which are insertable within housing section A 12. The metering discs 84, 86 each include a metering disc opening 88, 90. Each of the metering disc openings 88, 90 is configured in a tear drop contour design to provide a continuously variable predetermined amount of liquid materials 104, 106 from the cartridges 20, 22 responsive to rotation of the respective metering discs 84, 86 and their respective alignment with the cartridge outlet openings 116 and 118, which are in a fixed position and do not rotate.

After passing through the cartridge outlet openings 116, 118 and metering disc openings 88, 90, the metered outflow of liquid materials 104, 106 then travels through the seal plate openings 80 and 82 in seal plates 76, 78 before further flowing into liquid conduits 32, 34.

Referring now to FIG. 10, the previously referenced seal plates 76, 78 are disposed between the set of metering discs 84, 86 and the set of liquid conduits 32, 34. The seal plates 76, 78 are fixedly secured to liquid conduits 32, 34 in the second housing section 14 and removable therewith. Each of the seal plates 76, 78 have a seal plate opening 80, 82 and each of the respective seal plate openings 80, 82 are in fluid communication with a respective one of the liquid conduits 32, 34.

When cartridges 20, 22 containing liquid materials 104, 106 are resident, and metering discs 84, 86 have been rotated to a position which allows throughflow, and pump assembly 38 has been actuated, liquid materials 104, 106 from cartridges 20, 22 flow through flow metering mechanism 28, 30, the respective seal plate openings 80, 82 of the seal plates 76, 78, through the liquid conduits 32, 34, and ultimately through the coaxial dispensing opening 62. The seal plates 76, 78 help to ensure that cartridges 20, 22 remain properly positioned within cartridge chambers 16, 18 in first housing section 12, and also help to compress metering discs 84, 86 tightly against cartridges 20, 22.

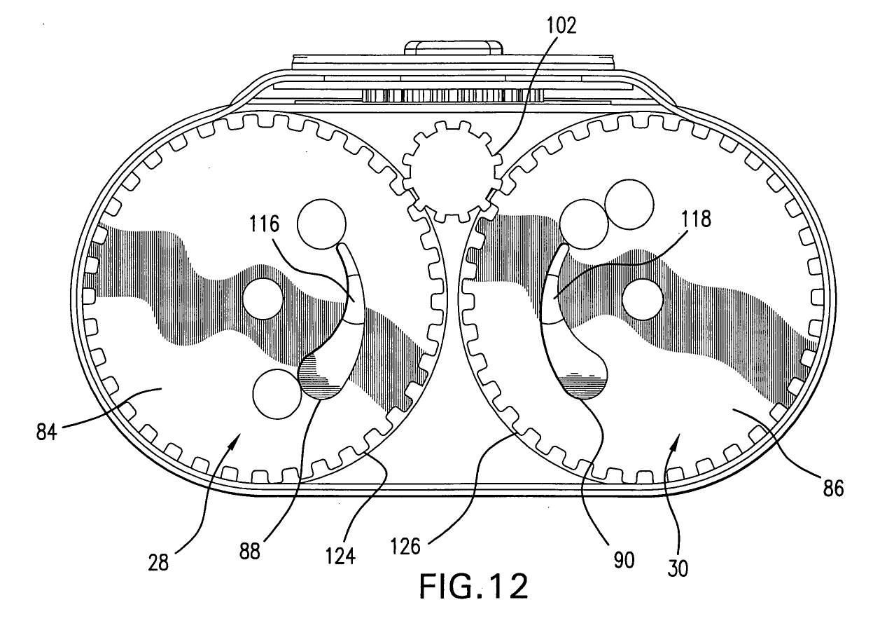

Referring again to FIG. 10, alignment of the metering disc openings 88, 90 with the cartridge outlet openings 116, 118 allows flow of liquid materials 104, 106 through the respective openings 116, 118 and 88, 90 before further passing through seal plate openings 80, 82 of the seal plates 76, 78 into the liquid conduits 32, 34. The metering disc openings 88, 90 can have any shape or configuration that is conducive to providing a predetermined ratio of the liquid materials 104, 106 from the cartridges 20, 22. For example, FIG. 12 shows the metering disc openings 88, 90 to have a tear-drop contour shape.

Referring now to FIG. 12, the two circles shown adjoining each of the metering disc openings 88 and 90 are not openings themselves, but signify closed positions on the metering discs 84 and 86. As part of metering discs 84, 86, said closed positions rotate into alignment with cartridge outlet openings 116, 118 to disallow flow from cartridge 20 when the user's variable selection is comprised of 0% from cartridge 20 and 100% from cartridge 22, to disallow flow from cartridge 22 when the user's variable selection is comprised of 100% from cartridge 20 and 0% from cartridge 22, or to disallow flow from both of the cartridges 20, 22 in the “off” condition.

Responsive to actuation of the metering control mechanism 36, as further described in the following paragraphs, metering discs 84, 86 are driven in opposing directions thereby allowing more flow through one of the metering disc openings 88 or 90 while allowing less flow through the other.

The metering control mechanism 36 comprises selection knob 92, shown in FIGS. 1-3, and its relationship with the selection drive assembly 94, which is illustrated in FIG. 11. Referring to FIG. 11, the selection drive assembly 94 directs the metering process which allows proper fluid flow through the metering discs 84 and 86, based on the user's input via selection knob 92.

The back side of selection knob 92 is fixedly attached to first gear 96 of the selection drive assembly 94 shown in FIG. 11. The selection drive assembly 94 includes first gear 96, as well as second gear 98 and third gear 100, with each gear matingly engaged to the next such that rotation of the third gear 100 is ultimately responsive to a rotation of the first gear 96, the rotation of which is coincident with rotation of selection knob 92.

The selection drive assembly 94 further includes a fourth gear 102 that is matingly engaged with third gear 100 and the set of metering discs 84 and 86. For purposes of illustration, first gear 96, second gear 98 and third gear 100 are in co-planar coupling and rotatably actuatable by rotation of selection knob 92 which is fixedly coupled to first gear 96. Fourth gear 102 matingly interfaces with third gear 100 and the metering discs 84 and 86, as seen in FIG. 11. Fourth gear 102 is co-planar with respect to metering discs 84 and 86 for responsive rotation thereof.

Rotation of selection knob 92 results in a rotation of the first gear 96 which causes rotation of the second gear 98. Rotation of the second gear 98 then respectively rotates third gear 100 which in turn rotates fourth gear 102. Rotation of fourth gear 102 results in rotation of the metering discs 84, 86, thereby allowing predetermined amounts of the liquid materials 104, 106 to flow from the cartridges 20, 22, through cartridge outlet openings 116, 118, through metering disc openings 88, 90, through seal plate openings 80, 82, through liquid conduits 32, 34, ultimately to exit the dispensing system 10 via coaxial dispensing opening 62.

As is clearly seen in FIG. 11, liquid conduits 32 and 34 are connected to seal plates 76 and 78, for allowing flow of liquid materials 104 and 106, after the metering process previously described, through liquid conduits 32 and 34 and through coaxial dispensing conduit 74 before exiting dispensing system 10 through coaxial dispensing opening 62. Liquid conduits 32 and 34 may similarly be formed of a plastic composition or some like material which provides a through communication from cartridges 20 and 22 into coaxial dispensing conduit 74 for passage therethrough external dispensing system 10 via coaxial dispensing opening 62.

As illustrated in FIG. 10, coaxial dispensing conduit 74 connects the previously referenced liquid conduits 32 and 34 with the coaxial dispensing opening 62, to carry metered liquid materials 104, 106 out of dispensing system 10. Coaxial dispensing conduit 74 is comprised of an outer dispensing conduit 70, which can be thought of as an outer sleeve, and inner dispensing conduit 72, and these two concentric conduits terminate in outer dispensing opening 66 and inner dispensing opening 68, respectively. Outer dispensing opening 66 and inner dispensing opening 68 define coaxial dispensing opening 62.

Liquid materials 104, 106 within each respective cartridge 20, 22 remain separate and do not come in contact with each other until exiting the coaxial dispensing opening 62. This is ensured by the flow of the liquid materials 104, 106 separately and respectively through the set of liquid conduits 32, 34 and then through outer dispensing conduit 70, inner dispensing conduit 72. The formation of the annularly contoured coaxial dispensing conduit 74, comprised of two segregated concentric conduits, ensures that the liquid materials 104, 106 do not come into contact with each other until exiting the dispensing system 10 through the outer dispensing opening 66 and inner dispensing opening 68 of the coaxial dispensing opening 62, at which time the liquid materials 104, 106 will mix each with the other, liquid material 104 enveloping liquid material 106 external dispensing system 10.

It is important that the liquid materials 104, 106 do not come in contact with each other until exiting the dispensing system, and this is achieved by the previously described coaxial arrangements. Ensuring that the liquid materials 104, 106 remain separate until exiting through the coaxial dispensing opening 62 achieves several objectives, among them to avoid problems related to residue of a mixed product remaining in the system to taint subsequent, possibly different selections, reducing product degradation risks, protecting integrity of food product flavors, and otherwise protecting against premature chemical interactions between the materials to be dispensed. Furthermore, as there is no mixing chamber, no back pressure is produced in the mixing chamber as may occur with several conventional dispensers.

Despite this purposeful segregation of components prior to delivery, an approximation of mixing is achieved outside of dispensing system 10 as soon as liquid materials 104, 106 exit, since liquid material 104 completely surrounds/envelops liquid material 106 upon exit due to the coaxial delivery configuration and further mixes upon hitting its target.

Referring now to FIGS. 1-4, the coaxial dispensing opening 62 can be sealed by closure 64, which is hingedly attached to the coaxial dispensing conduit 74 of dispensing system 10. In this manner, the closure 64 is used to cover the coaxial dispensing opening 62, thereby preventing leakage of any residual liquid materials 104, 106 from the coaxial dispensing opening 62. The closure 64 also prevents any finger-transmitted, airborne or other contaminants from entering the dispensing system 10 through coaxial dispensing opening 62 or contaminating the opening itself when dispensing system 10 is in a closed position.

Referring to FIGS. 6, 8, 9, 10 and 14-17, cartridges 20, 22 are insertable within cartridge chambers 116, 118 in first housing section of dispensing system 10. Once positioned within first housing section 12, cartridges 20, 22 are in abutting contact with the respective seal plates 76, 78, thereby providing fluid communication from the internal chambers of the cartridges 20, 22 through the set of flow metering mechanisms 28, 30, seal plate openings 80, 82 in the seal plates 76, 78 into the set of liquid conduits 32, 34 and to the coaxial dispensing opening 62. As described above, once the cartridges 20, 22 are inserted within first housing section 12, they are in communication with the branch air conduits 52, 54 of the pump assembly 38.

Thus, as previously described, cartridge pistons 58, 60 within the cartridges 20, 22, once acted upon by the pump assembly (air flow from the main air conduit 50 and branch air conduits 52, 54) causes longitudinal displacement of the cartridge pistons 58, 60 and thereby results in displacement of the liquid materials 104, 106 out of the cartridges 20, 22 in a metered manner and ultimately through coaxial dispensing opening 62.

Referring to FIGS. 1-5, 10, 11 and 13, there is shown the coaxial dispensing opening 62 detailed above. The coaxial dispensing opening 62 is in fluid communication with the set of liquid conduits 32, 34. By being in fluid communication with the set of liquid conduits 32, 34, liquid materials 104 and 106 flow from the cartridges 20, 22 through the set of liquid conduits 32, 34 and finally through the coaxial dispensing opening 62 external the system 10.

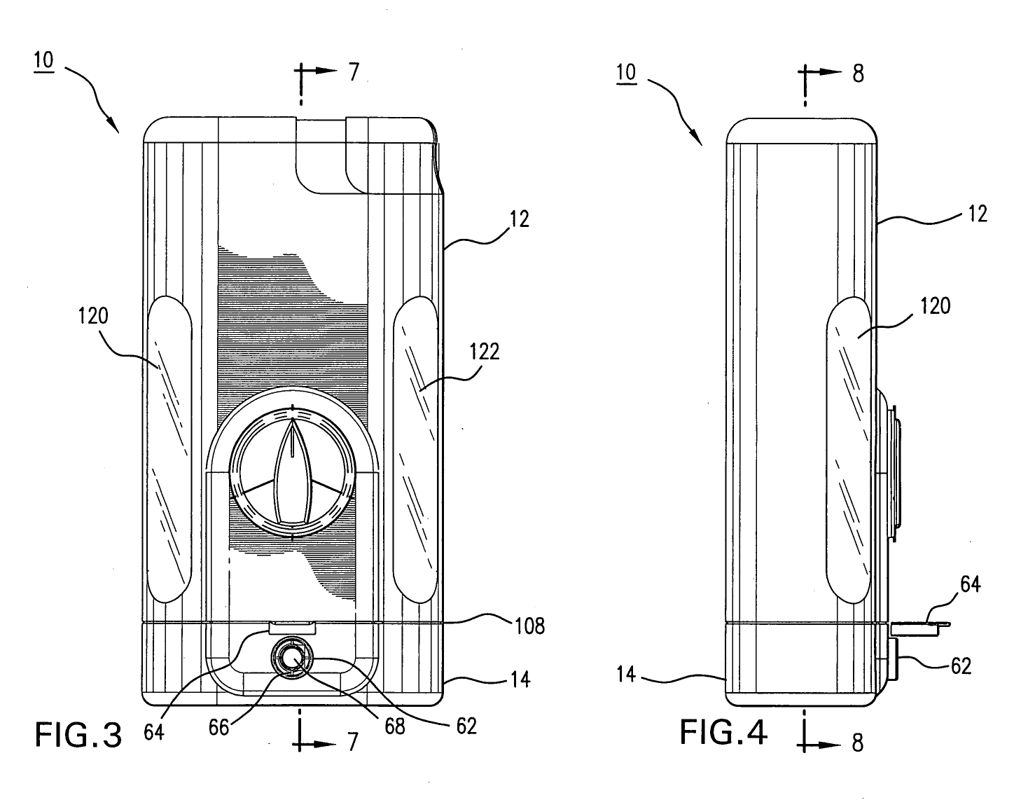

Referring now to FIGS. 3 and 10, the coaxial dispensing opening 62 includes an outer dispensing opening 66 and an inner dispensing opening 68. The outer dispensing opening 66 and the inner dispensing opening 68 define a outer dispensing conduit 70 and a inner dispensing conduit 72. The outer and inner dispensing conduits 70, 72 form an annularly contoured coaxial dispensing conduit 74 and are in fluid communication with a respective one of the set of liquid conduits 32, 34. Closure 64, which is attached to coaxial dispensing conduit 74, is used to seal coaxial dispensing opening 62 between uses of dispensing system 10. Conduits 70, 72, 74 may extend outwardly from second housing section 14 for interface with closure 64 and to facilitate targeted placement of the dispensed product.

Referring to FIG. 9, the pump assembly 38 is shown as being actuated in a horizontal manner. However, the pump assembly 38 could, in a similar manner, be orientated vertically or in an angular manner and therefore actuated in a vertical or angular manner, with corresponding revisions made to the configuration of associated components. The orientation of the pump assembly, whether horizontal, vertical or angular, is within the scope of the subject inventive concept of the present invention.

The metering control mechanism 36 is oriented in a manner in which it is adjacent to the cartridges when the cartridges 20, 22 are inserted within the first housing section 12 of the dispensing system 10. However, the metering control mechanism 36 could, in a similar manner, be located at the bottom of the dispensing system 10 or above the cartridges 20, 22 or elsewhere located, with corresponding revisions made to the configuration of associated components, and still function in the same manner as detailed above. The location of the metering control mechanism 36, whether adjacent to the cartridges 20,22, or located at the bottom of the dispensing system 10, or located above the cartridges 20, 22, or located elsewhere is within the scope of the inventive concept of the present invention.

The cartridges 20, 22 are detailed above as being insertable through the bottom of the first housing section 12. However, the cartridges 20, 22 could, in a similar manner, be inserted from a side or top of the dispensing system 10, with corresponding revisions made to the configuration of associated components. The manner of orientation of the cartridges, 20, 22, whether it is from the side, the top, the bottom or at an angle with respect to the dispensing system 10, is within the scope of the subject inventive concept of the present invention.

Referring to FIGS. 1-5 and 10-11, the coaxial dispensing opening 62 and related conduits and closure are detailed above as being located on the second housing section 14 of the dispensing system 10. However, coaxial dispensing opening 62 and its related conduits and closure 64 could, in a similar manner, be located at any point on the dispensing system 10, with corresponding revisions made to the configuration of associated components. Furthermore, closure 64 is detailed above as being hingedly attached to the coaxial dispensing conduit 74. However, closure 64, in a similar manner, could be attached in a manner in which closure 64, whether a cap as illustrated or a sliding door or other closure device, is automatically opened and/or actuated by the pump assembly 38 or its opening and closing action could be coupled to another function of the dispensing system 10 such as rotation of the selection knob 92.

In the accompanying illustrations, the metering discs 84 and 86 are shown to include metering disc openings 88 and 90, of a tear-drop shape, which in conjunction with the fixed cartridge outlet openings 116 and 118, act to meter the proper throughput of liquid materials 104 and 106. Alternatively the metering openings included with 84 and 86 could be of any number and shape (for example, a contoured succession of discrete openings of increasing/decreasing size rather than a continuous tear-drop shape) which precisely permit exit from the cartridges 20 and 22 of the specific amount of liquid materials 104 and 106 which correctly corresponds to the selection increments provided on selection knob 92. Variations in the size, type and/or orientation of openings used to accomplish this metering function are within the subject inventive concept of the present invention.

FIG. 11 shows a selection drive assembly 94 of four mated gears (96, 98, 100, 102) used to translate the user's rotation of selection knob 92 into the proper rotation of metering discs 84, 86. However, the size, number, type and orientation of these gears (or single gear) is largely dependent on the distance between the selection knob 92 and metering discs 84, 86 and their respective orientations on or within dispensing system 10, and therefore this gear assembly could be of whichever configuration accomplishes the function of driving the metering discs 84, 86 correctly in response to the user's selection (via selection knob 92), and any such variations in the gear assembly which perform this function in a similar manner are within the subject inventive concept of the present invention.

The present invention is also directed to a method of using a dispensing system 10 to dispense liquid materials 104, 106. The method of using a dispensing system 10 includes the step of selecting a predetermined ratio of liquid material 104, 106 to be dispensed by actuating the metering control mechanism 36. This is followed by the step of actuating the pump displacing member 46 within the pump assembly 38 thereby compressing atmospheric air, as is seen in FIG. 9.

Again looking at FIG. 9, the compressed atmospheric air then displaces the cartridge pistons 58, 60 within each respective cartridge 20, 22, as is shown by the directional arrows which represent air flow through branch conduits 52, 54 acting upon cartridge pistons 58, 60.

Next, liquid materials 104, 106 are displaced out of the cartridges 20, 22 responsive to the displacement of the cartridge pistons 58, 60. The liquid materials 104, 106 are displaced through the flow metering mechanism 28, 30 and metering openings mechanically coupled to the metering control mechanism 36. Prior to dispensing the liquid materials 104, 106, the liquid materials 104, 106 are isolated each from the other in their respective cartridges 20, 22. The liquid materials 104, 106 are then dispensed through coaxial dispensing opening 62 (at which point liquid materials 104, 106 will mix) in the predetermined ratio selected by a user.

Upon release of the displacing member 46, the step of creating a negative pressure drop occurs between the cartridge pistons 58, 60 and the atmosphere whereby the liquid materials 104, 106 are reversibly displaced from the coaxial dispensing opening 62.

The step of selecting predetermined ratio of liquid materials 104, 106 further includes the step of rotating a selection knob 92 to actuate the selection drive assembly 94 that forms part of the metering control mechanism 36. The step of selecting predetermined ratio includes selecting a predetermined volume ratio of liquid materials 104, 106 within a range of 0-100%, wherein the total volume of liquid materials chosen equal 100%; this further includes the step of selecting any of a continuous range of settings using a metering control mechanism 36 which results in metering 0% to 100% from either cartridges 20, 22, so long as the combined ratio from both cartridges totals 100%. This allows a user to choose a setting using metering control mechanism 36 which results in total closure of both cartridges 20, 22 (disallowing output of liquid material 104 or 106 from any cartridge).

It would be appreciated by those skilled in the art that changes could be made to the embodiment described above without departing from the broad inventive concept thereof. It is understood, therefore, that this invention is not limited to the particular embodiments disclosed, but is intended to cover modifications within the spirit and scope of the present invention as defined by the appended claims.

What is claimed is:

1. An adjustable and selective dispensing system for dispensing at least two liquid materials comprising:
a housing having a set of cartridge chambers;
a set of cartridges housing said liquid materials, each of said cartridges respectively being received in one of said set of cartridge chambers of said housing, said cartridges having a piston end and a metering end;
a set of cartridge pistons being positioned in a respective one of said cartridges at said piston end thereof, each of said cartridge pistons being longitudinally displaceable within said set of cartridges;
a set of flow metering mechanisms adjacent a respective one of said cartridges at said metering end thereof for selectively dispensing pre-determined portions of said liquid materials from said cartridges;
a set of conduits adjacent each of said flow metering mechanisms for providing said predetermined portions of said liquid materials to be dispensed, said set of conduits including a set of seal plates being disposed between said flow metering mechanisms and said set of conduits, said seal plates being in abutting contact with said flow metering mechanisms;
a metering control mechanism rotationally actuating said flow metering mechanisms for selecting the desired predetermined portions of said liquid materials from each of said cartridges;
a selection drive assembly coupling said metering control mechanism to said flow metering mechanisms; and
a pump assembly including a pump chamber and a pump piston, said pump piston being displaceable within said pump chamber, said pump assembly being positioned within said housing.

2. The adjustable and selective dispensing system for dispensing at least two liquid materials as recited in claim 1, wherein said housing includes a first housing section and a second housing section, said second housing section being displaceably removable with respect to said first housing section.

3. The adjustable and selective dispensing system for dispensing at least two liquid materials as recited in claim 1, wherein said pump assembly further includes an actuating mechanism, said actuating mechanism including a displacing member, a spring member and said pump piston, wherein displacement of said displacing member displaces said pump piston within said pump chamber.

4. The adjustable and selective dispensing system for dispensing at least two liquid materials as recited in claim 1, wherein said pump mechanism further comprises a main air conduit, said main air conduit connected to said pump chamber and bifurcating into a set of branch air conduits, said branch air conduits being in alignment with the piston end of each of said cartridges, wherein said main air conduit and said set of branch air conduits direct compressed air generated by said pump assembly to said respective cartridge pistons.

5. The adjustable and selective dispensing system for dispensing at least two liquid materials as recited in claim 1, wherein said pump assembly further comprises a vent and check valve.

6. The adjustable and selective dispensing system for dispensing at least two liquid materials as recited in claim 1, wherein said housing includes a coaxial dispensing opening, said coaxial dispensing opening being in fluid communication with said set of conduits, wherein said liquid materials exit said dispensing system through said coaxial dispensing opening.

7. The adjustable and selective dispensing system for dispensing at least two liquid materials as recited in claim 1, wherein said dispensing system further comprises a closure therein.

8. The adjustable and selective dispensing system for dispensing at least two liquid materials as recited in claim 6, wherein said coaxial dispensing opening includes an inner dispensing opening and an outer dispensing opening defining an inner dispensing conduit and an outer dispensing conduit, said inner and outer dispensing conduits being in fluid communication with a respective one of said set of conduits, said inner and outer dispensing conduits forming an annularly contoured coaxial dispensing conduit.

9. The adjustable and selective dispensing system for dispensing at least two liquid materials as recited in claim 1, wherein each of said seal plates have a respective seal plate opening, each of said seal plate openings being in fluid communication with a respective one of said set of conduits.

10. The adjustable and selective dispensing system for dispensing at least two liquid materials as recited in claim 1, wherein said set of flow metering mechanisms are rotatable metering discs.

11. The adjustable and selective dispensing system for dispensing at least two liquid materials as recited in claim 10, wherein said metering discs each include a metering disc opening for providing said predetermined portion of said liquid materials from said cartridges responsive to a rotation of a respective metering disc.

12. The adjustable and selective dispensing system for dispensing at least two liquid materials as recited in claim 11, wherein said metering disc openings have a tear-drop contour shape.

13. The adjustable and selective dispensing system for dispensing at least two liquid materials as recited in claim 1, wherein said set of flow metering mechanisms are rotatably attached to a respective one of said cartridges at said metering end thereof.

14. The adjustable and selective dispensing system for dispensing at least two liquid materials as recited in claim 1, wherein said set of cartridges are in abutting contact with said seal plate members thereby providing fluid communication from internal chambers of said cartridges through said set of flow metering mechanisms and through said seal plate openings in said seal plates into said set of conduits.

15. The adjustable and selective dispensing system for dispensing at least two liquid materials as recited in claim 1, wherein said metering control mechanism includes a selection knob positioned on said housing.

16. The adjustable and selective dispensing system for dispensing at least two liquid materials as recited in claim 1, wherein said selection drive assembly further comprises a first gear, a second gear and a third gear in mating engagement for rotation of said third gear responsive to a rotation of said first gear.

17. The adjustable and selective dispensing system for dispensing at least two liquid materials as recited in claim 16, wherein said selection drive assembly further comprises a fourth gear matingly engaged with said third gear and said set of flow metering mechanism.

18. The adjustable and selective dispensing system for dispensing at least two liquid materials as recited in claim 1, wherein each of said cartridges respectively includes a cartridge piston air bypass, said cartridge piston air bypass allowing air to bypass each of said respective cartridge piston when each respective cartridge piston is displaced longitudinally by a pre-determined length.

19. A disposable and replaceable cartridge to contain liquid material for use in a dispensing system comprising:
a hollow cylindrically shaped housing;
a piston located at one end of said housing;
an opening located at an opposite end of said housing;
a rotatable metering disc fixedly attached to said opposite end of said housing and including a metering disc opening;
a locking mechanism, said locking mechanism preventing rotation of said metering disc when said cartridge is not properly inserted or is removed from said dispensing system; and
a cartridge alignment member located on an outer surface of said housing, wherein said cartridge alignment member ensures proper insertion of said cartridge into said dispensing system.

20. The disposable and replaceable cartridge holding liquid material for use in a dispensing system as recited in claim 19, further comprising a cartridge piston air bypass, wherein said cartridge piston air bypass allows air to bypass said cartridge piston when said cartridge piston reaches said opposite end of said cartridge.

21. A method of using a dispensing system to dispense liquid materials comprising the steps of:
(a) selecting a predetermined ratio of said liquid materials to be dispensed by actuating a metering control mechanism;
(b) actuating a pump displacing member of a pump assembly whereby atmospheric air is compressed;
(c) displacing a set of pistons positioned within a respective one of a set of cartridges housing said liquid materials with said compressed air;
(d) displacing said liquid materials external said cartridges responsive to the displacement of said set of pistons through a set of flow metering mechanisms having variable metering openings mechanically coupled to said metering control mechanisms; and
(e) dispensing said liquid materials through a coaxial dispensing opening positioned on said dispensing system in said predetermined ratio.

22. A method of using a dispensing system to dispense liquid materials as recited in claim 21, wherein the step (a) further comprises the step of rotating a selection knob to actuate a drive assembly forming part of said metering control mechanism.

23. The method of using a dispensing system to dispense liquid materials as recited in claim 21, wherein the step (a) further comprises the step of selecting a predetermined volume ratio of said liquid materials within a range of 0-100%, wherein the total volume of liquid materials chosen equals 100%.

24. The method of using a dispensing system to dispense liquid materials as recited in claim 23, wherein the step of selecting a pre-determined volume ratio includes the step of selecting any of a continuous range of settings using said metering control mechanism whereby any predetermined volume between 0% to 100% may be metered from each of said cartridges wherein said volume summation of said liquids equals 100%.

25. The method of using a dispensing system to dispense liquid materials as recited in claim 21, wherein the step (d) further comprises the step of isolating said liquid materials each from the other prior to dispensing said liquid materials from said dispensing system.

26. The method of using a dispensing system to dispense liquid materials as recited in claim 21 including the step of creating a negative pressure difference between said pistons and said atmosphere for displacing said set of pistons upon release of said pump displacing member whereby said liquid materials are reversibly displaced in the area of said coaxial dispensing opening.
